(19) United States
(12) Patent Application Publication
(10) Pub. No.: US 2026/0245437 A1
(43) Pub. Date: Aug. 20, 2026

(54) GAMING MACHINE AND METHOD FOR PLAYING MULTIPLE SIMULTANEOUS GAMES

(71) Applicant: Aristocrat Technologies, Inc., Las Vegas, NV (US)

(72) Inventors: David Marsh, Charlottesville, VA (US); Daniel Marston, Reno, NV (US); Kevin Walcomb, Reno, NV (US)

(21) Appl. No.: 19/181,271

(22) Filed: Apr. 16, 2025

Related U.S. Application Data
(60) Provisional application No. 63/638,528, filed on Apr. 25, 2024.

(51) Int. Cl. G07F 17/32

(52) U.S. Cl. CPC G07F 17/329; G07F 17/3213

(57) ABSTRACT

An electronic gaming machine may include a display device and a game controller in communication with the display device. The game controller may include a processor and memory. The game controller may be configured to cause display, on the display device, of a user interface (UI) that includes multiple independent electronic wagering games, where at least two of the games have different rules for winning and/or different associated pay tables. The game controller may also initiate a game event that applies to each of the games and may also generate multiple graphics changes for each of the games based on the event. The game controller may also dynamically update, on the display device, each electronic wagering game presented in the UI using the generated graphics changes. Various other methods, systems, and computer- readable media are also disclosed.

### CROSS-REFERENCE TO RELATED APPLICATIONS

This application claims priority to and the benefit of U.S. Provisional Patent Application No. 63/638,528, filed on April 25, 2024, which application is incorporated by reference herein in its entirety.

### BACKGROUND

Electronic gaming machines ("EGMs") or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, ora bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of "game credits" that are awarded during play, the game credits are typically added to a credit meter total on the EGM and can be provided to the player upon completion of a gaming session or when the player wants to "cash out."

"Slot" type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a "pay table" which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Casinos and other gaming establishments typically have multiple different types of electronic wagering games. Some of these games include Class III games, which include traditional slot type games or matching games. Other gaming establishments may provide Class II games, which are typically bingo-based games. These bingo-based games may include "scratcher" games in which a person may scratch or uncover scratchable locations on a game card. These scratchable locations may reveal a prize value or other prize element. If the number corresponds to a number drawn as part of the bingo game, depending on specific rules for that game, the user may win prizes of varying value.

### BRIEF SUMMARY

As will be described in greater detail below, the present disclosure generally describes electronic gaming machines, systems, and methods for presenting multiple simultaneous electronic wagering games that are tied to a single game event or series of game events.

In one example, an electronic gaming machine (EGM) may be provided. The EGM may include a display device and a game controller in communication with the display device. The game controller may include at least one processor and at least one memory. The game controller may be configured to: cause display, on the display device, of a user interface (UI) that includes multiple independent electronic wagering games. At least two of the electronic wagering games may have different rules for winning and/or different associated pay tables or paylines. The game controller may then initiate an electronic wagering game event that applies to each of the independent electronic wagering games, generate specified graphics changes for each of the electronic wagering games based on the initiated electronic wagering game event, and may then dynamically update, on the display device, each electronic wagering game presented in the UI using the generated graphics changes.

In some cases, at least two of the electronic wagering games may include electronic scratching games in which a user forms a winning pattern in a plurality of scratchable locations on an electronic game card. In some embodiments, a player of the electronic wagering games may interact with a single UI element that, upon selection, scratches each of the scratchable locations in each of the electronic wagering games. In some cases, a player of the electronic wagering games may interact with the UI to individually select at least some of the scratchable locations on the electronic game card.

In some embodiments, after a series of electronic wagering game events, at least one of the electronic wagering games may include an enhanced win that, itself, includes a natural win and at least one wild in a scratchable location. In some examples, a wild in at least one scratchable location may enhance other natural wins and may create at least one other, non- natural win. In some cases, after a series of electronic wagering game events, at least one of the electronic wagering games may include an instant cash scratchable location that results in a win without having a winning pattern.

In some embodiments, after a series of electronic wagering game events, at least one of the electronic wagering games may include a natural match and multiple instant cash scratchable locations. As such, the instant cash scratchable location with the highest value may be applied to each of multiple different instant cash scratchable locations.

In some cases, the electronic wagering game event may include a shape selected from among multiple different shapes. In such cases, scratchable locations having a selected shape may be winning locations, winning a monetary amount specified in those scratchable locations that have the selected shape.

In some examples, after a series of electronic wagering game events, at least one of the electronic wagering games may include at least one scratchable location that allows each losing scratchable location within the at least one electronic wagering game to be rescratched. In such cases, after rescratching the losing scratchable locations, at least one scratchable location again may include an element that allows losing scratchable locations to be rescratched, and at least one losing scratchable location may be rescratched again.

In some cases, after a series of electronic wagering game events, at least one of the electronic wagering games may include at least one scratchable location that includes a wheel bonus. In such cases, a wheel bonus may be activated for each of the electronic wagering games. In some examples, the wheel bonus may include at least one wheel spin, where, upon spinning the wheel, the player wins at least one of the prizes depicted on the wheel. In some cases, if each of the electronic wagering games has a wheel bonus, at least one instant win is added for each electronic game card to the wheel.

In some embodiments, the rules for winning at least one of the electronic wagering games may include specified wining patterns for scratchable locations including at least one of: a star pattern, a corner pattern, a diamond-shaped pattern, or other, more traditional pattern (e.g., diagonal). In some examples, upon winning at least one of the independent electronic wagering games, at least one bonus electronic game card may be displayed in the UI, where the electronic game card is a wining card that will pay out at least one prize.

In some cases, a bonus electronic game card may be displayed for each of the electronic wagering games. In such cases, each of the scratchable locations may automatically be scratched and tallied for each electronic wagering game. In some examples, the odds of obtaining a bonus electronic game card may increase based on the number of electronic wagering games being played simultaneously.

In some embodiments, a corresponding method of electronic gaming may be provided. The method of electronic gaming may be implemented by an electronic gaming system that includes at least one processor in communication with at least one memory device and a display device. The method may include: causing display, on the display device, of a user interface (UI) that includes multiple independent electronic wagering games, where at least two of the electronic wagering games have different rules for winning and/or different associated pay tables. The method may also include initiating an electronic wagering game event that applies to each of the independent electronic wagering games, generating specified graphics changes for each of the electronic wagering games based on the initiated electronic wagering game event, and dynamically updating, on the display device, each electronic wagering game presented in the UI using the generated graphics changes.

A corresponding non-transitory computer-readable medium may also be provided that includes one or more computer-executable instructions that, when executed by at least one processor of a computing device, cause the computing device to: cause display, on the display device, of a user interface (UI) that includes multiple independent electronic wagering games, where at least two of the electronic wagering games have different rules for winning and/or different associated pay tables. The computing device may also initiate an electronic wagering game event that applies to each of the independent electronic wagering games, generate specified graphics changes for each of the electronic wagering games based on the initiated electronic wagering game event, and dynamically update, on the display device, each electronic wagering game presented in the UI using the generated graphics changes.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an exemplary diagram showing several electronic gaming machines (EGMs) networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 is a flow diagram of an exemplary method for presenting multiple simultaneous electronic wagering games that are tied to a single game event or series of game events.

FIGS. 5A, 5B, and 5C illustrate example embodiments of a plurality of independent electronic wagering games that are tied to a single game event or series of game events.

FIGS. 6A and 6B illustrate example embodiments of an electronic wagering game that has specific rules for winning and/or specific associated pay tables.

FIGS. 7A and 7B illustrate alternative example embodiments of an electronic wagering game that has specific rules for winning and/or specific associated pay tables.

FIGS. 8A and 8B illustrate alternative example embodiments of an electronic wagering game that has specific rules for winning and/or specific associated pay tables.

FIG. 9 illustrates an example embodiment of an electronic wagering game that has specific rules for winning and/or specific associated pay tables.

FIGS. 10A and 10B illustrate example embodiments in which a wheel bonus is implemented across multiple independent electronic wagering games.

FIGS. 11A and 11B illustrate example embodiments in which bonus cards are implemented in one or more independent electronic wagering games.

FIG. 12 illustrates an example embodiment in which a corresponding bingo card and/or a corresponding ball call may be shown on-screen.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The embodiments herein are generally directed to an electronic gaming system for wagering that may include an electronic gaming machine having a display, one or more input devices, a wager acceptor, and a game controller coupled to the display, the input devices, and the wager acceptor. The game controller may be configured to control the display to present a plurality of wager options on different electronic wagering games. The game controller may present these various wager options on each of the different electronic wagering games simultaneously. At least in some cases, each of the electronic wagering games may be governed by different rules and/or pay tables. The game controller may be configured to operate each of the games using a common wagering event (e.g., a single bingo-based ball draw) that is applied, individually, to each of the electronic wagering games. The game controller may also present different options, bonuses, and events to users playing the various games simultaneously. Any updates to the games, as a results of these events, are then dynamically generated and incorporated into the display of the electronic gaming machine.

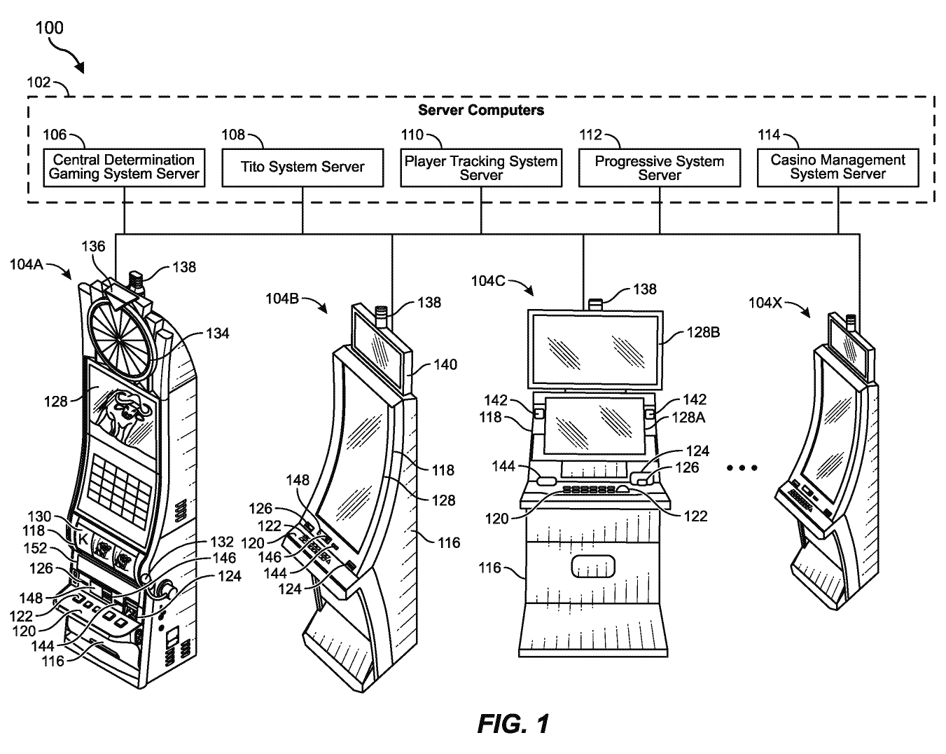

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A- 104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XLTM model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a "ticket- in" reader that allows the player to use a casino issued credit ticket to load credits onto the gaming device 104A (e.g., in a cashless ticket ("TITO") system). In such cashless implementations, the gaming device 104A may also include a "ticket-out" printer 126 for outputting a credit ticket when a "cash out" button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back- lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

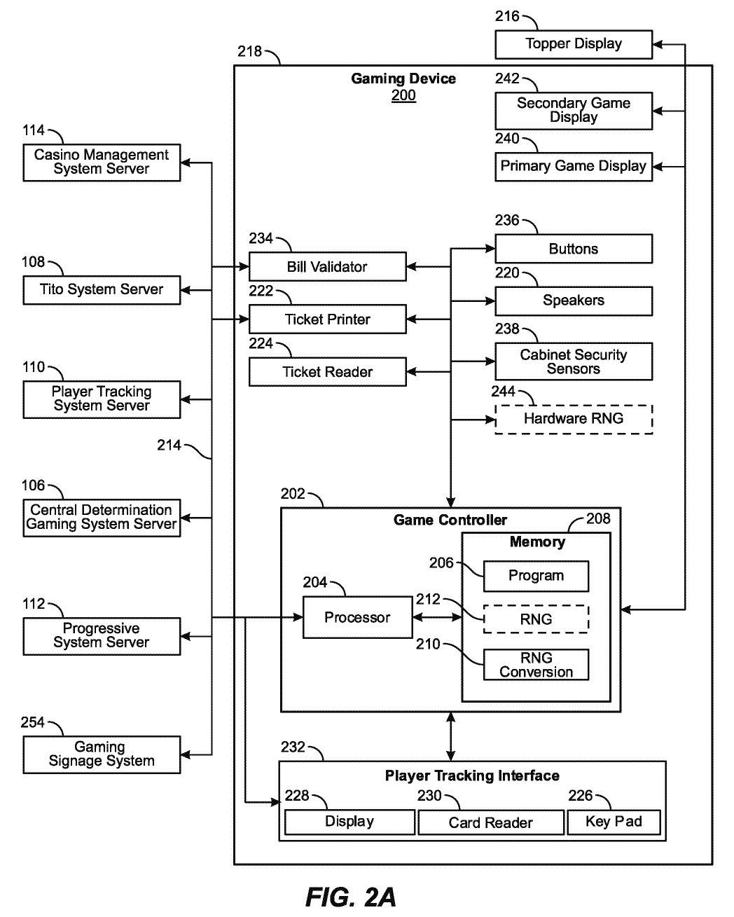

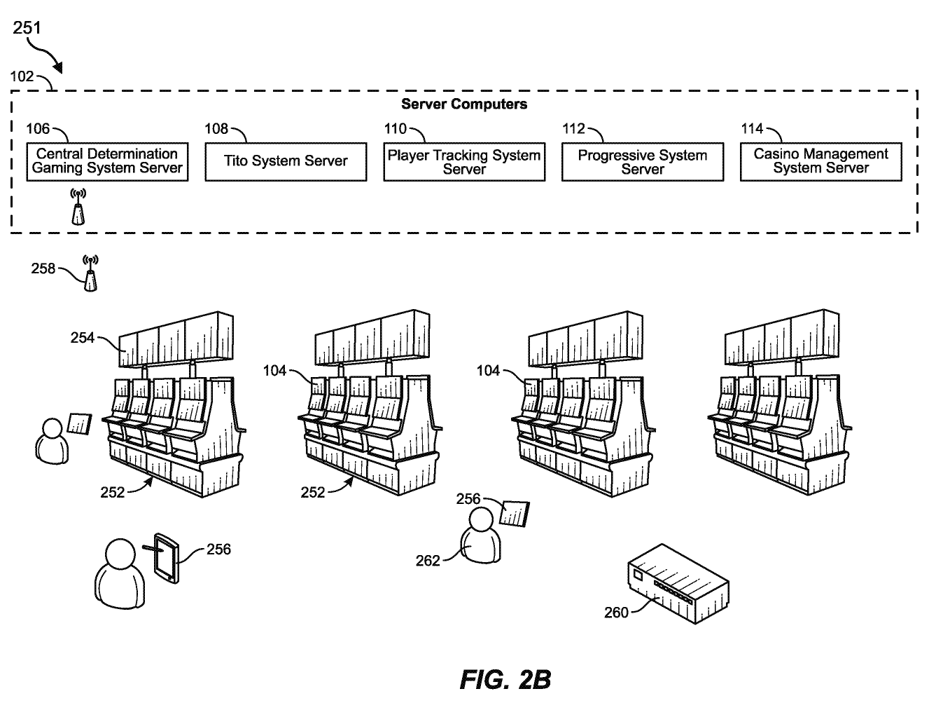

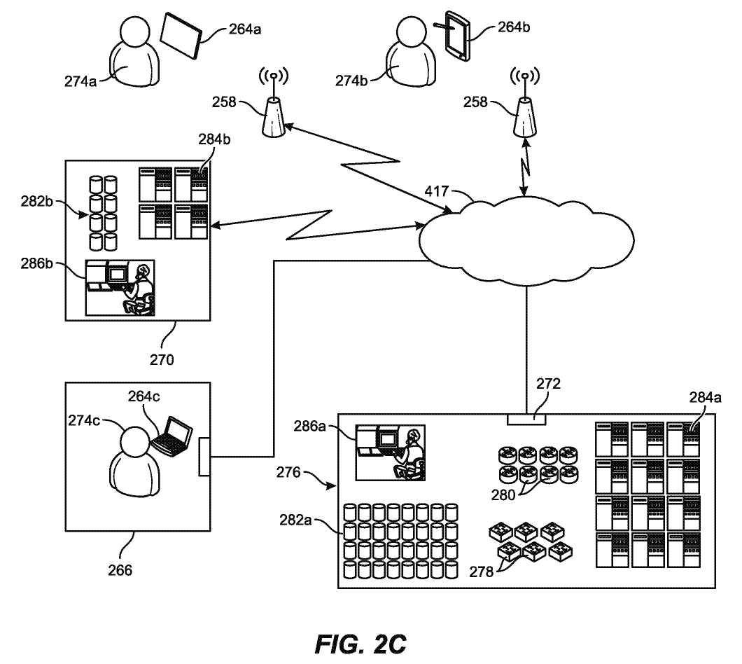

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the ArcTM model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the HelixTM model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a playertracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term "game instance" refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a "random number").

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g. amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at anytime. The player may also optionally insert a loyalty club card into the card reader 230. During the game, the player views with one or more Uls, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be "cashed-in" for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a "cash out" signal to a kiosk 260 via a wireless link in response to receiving a "cash out" indication from a casino patron. The kiosk 260 may provide monetary credits to the casino patron 262 corresponding to the "cash out" signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 270a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286a. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's "cash in" selections, wagering game results and a player's "cash out" instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not "cash out" for monetary credit after a gaming session. Moreover, although the financial institution data center 270 and the gaming data center 276 include their own servers and storage devices in this example, in some examples the financial institution data center 270 and/or the gaming data center 276 may use offsite "cloud-based" servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as "apps" and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as "apps" and downloadable by authorized users.

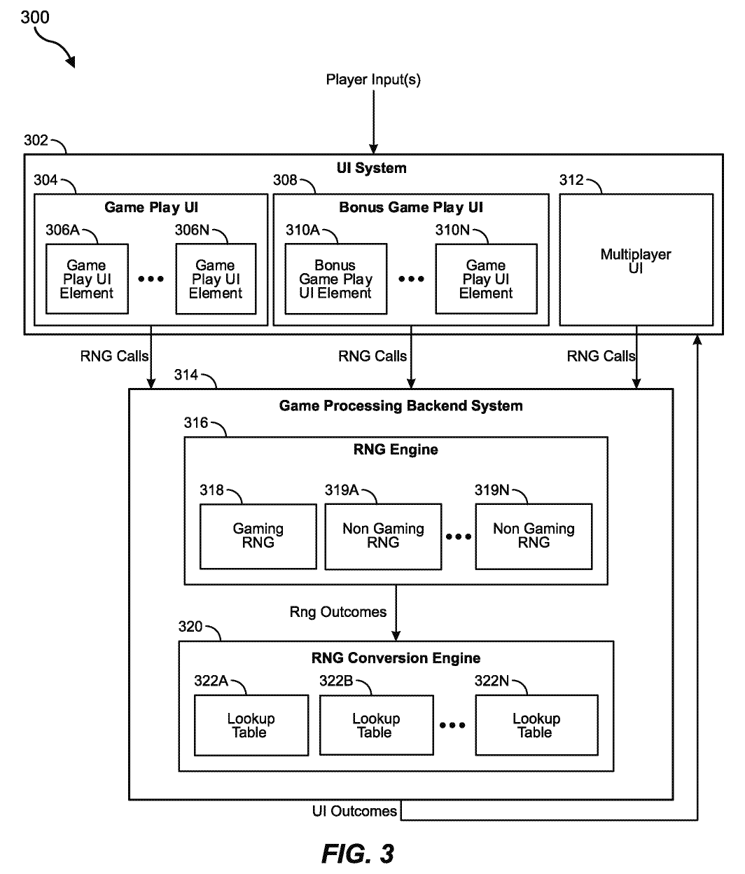

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A- 104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more Uls that a player can interact with. The UI system 302 could include one or more game play Uls 304, one or more bonus game play Uls 308, and one or more multiplayer Uls 312, where each UI type includes one or more mechanical Uls and/or graphical Uls (GUIs). In other words, game play UI 304, bonus game play UI 308, and the multiplayer UI 312 may utilize a variety of UI elements, such as mechanical UI elements (e.g., physical "spin" button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non- gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

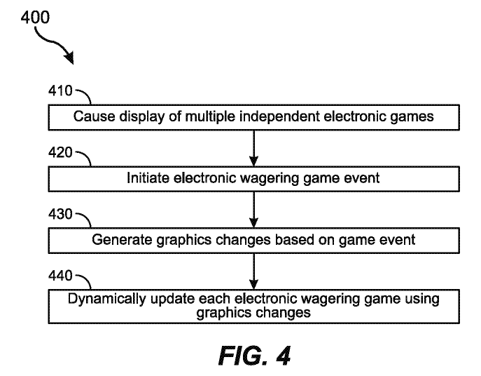

Turning now to FIG. 4, method 400 of FIG. 4 illustrates a flow diagram of an exemplary computer-implemented method 400 for presenting multiple simultaneous electronic wagering games that are tied to a single game event or series of game events. The steps shown in FIG. 4 may be performed by any suitable computer-executable code and/or computing system, including the electronic gaming machines illustrated in FIGS. 1-3. In one example, each of the steps shown in FIG. 4 may represent an algorithm whose structure includes and/or is represented by multiple sub-steps, examples of which will be provided in greater detail below.

An electronic wagering game may be initiated on an EGM, using any combination of the components 104A-104X. Specifically, a player may fund the wagering game via bill validator 234 and/or ticket reader 224. Once funded, a primary game, which may include a plurality of scratchable locations, each potentially including one of a plurality of different symbols, may appear on a display, such as on primary game display 240.

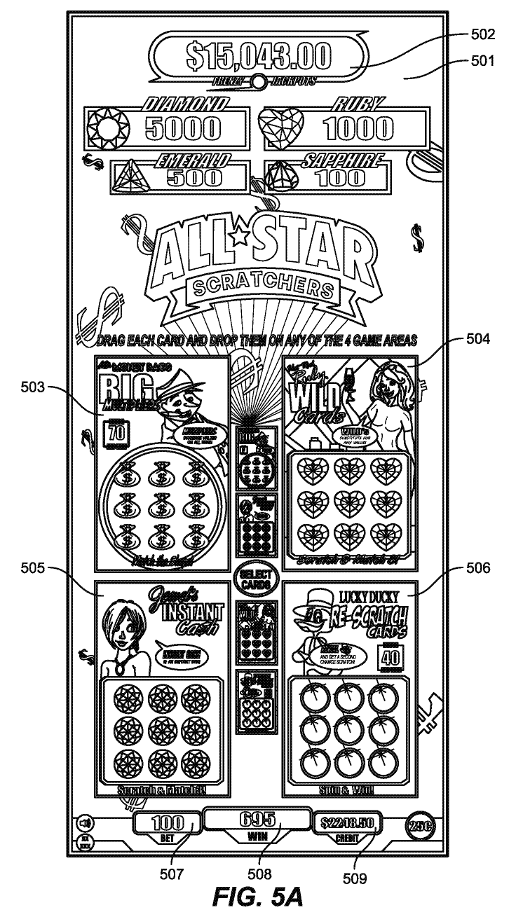

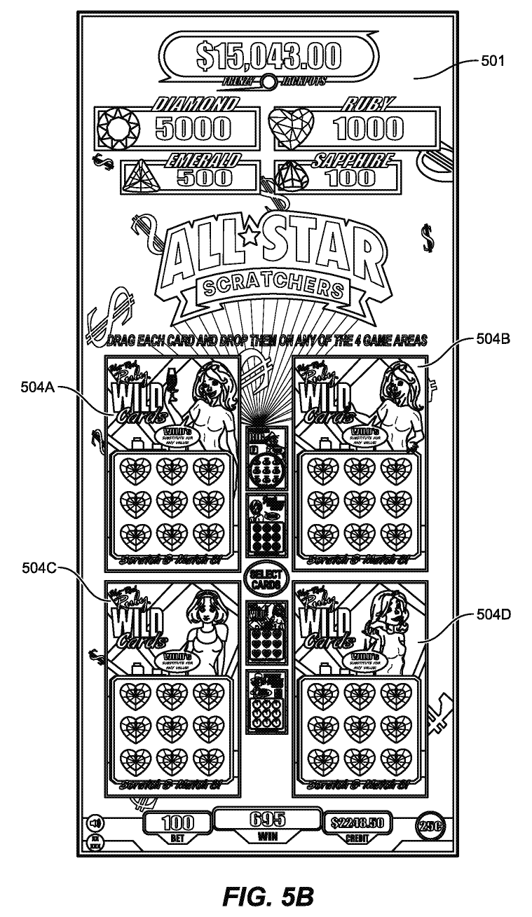

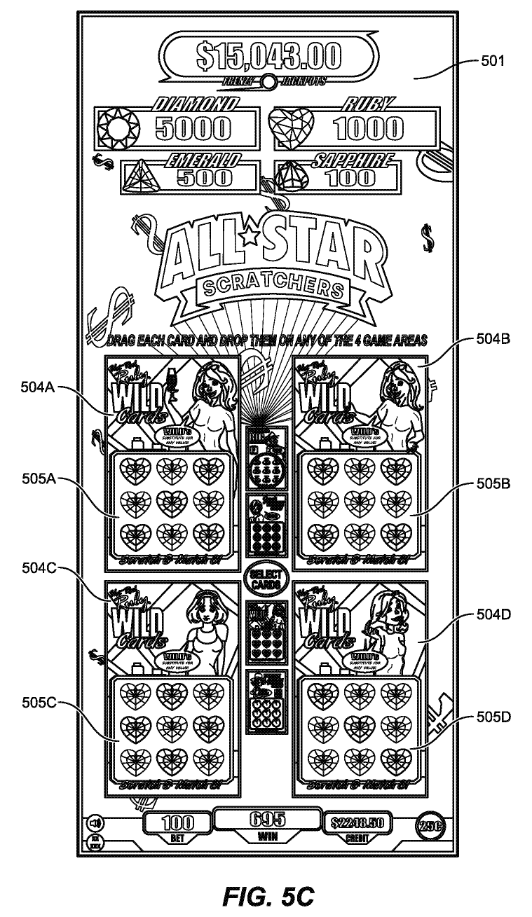

At step 410 in FIG. 4, method 400 may include causing display, on a display device (e.g., 240), of a user interface (UI) that includes multiple independent electronic wagering games. At least in some embodiments, the method 400 may be controlled by or carried out by a game controller that is part of an electronic gaming machine (EGM) (as generally illustrated in FIGS. 1-3). The EGM may include a display device (e.g., 240) and a game controller (e.g., 202) in communication with the display device. The game controller may include at least one processor 204 and at least one memory 208. The game controller may be configured to cause display, as part of step 410, of a user interface that includes multiple independent electronic wagering games. Examples of such electronic wagering games are shown in FIGS. 5A-11B.

For example, embodiment 500 of FIG. 5A illustrates a user interface 501 that includes four different electronic wagering games (503, 504, 505, and 506). Each of these electronic wagering games may include different rules for winning and/or different associated pay tables or paylines. In many of the embodiments that are described herein, the electronic wagering games may be electronic scratching games in which a user forms a winning pattern in various scratchable locations on an electronic game card. In the embodiments illustrated in the Figures, the electronic game cards may include nine scratchable locations, while in other cases, more or fewer scratchable locations may be used. It will be recognized that the principles described herein may be applied to many different types of electronic wagering games, and that electronic scratching games are only one example of such electronic wagering games. Indeed, the embodiments herein may apply to substantially any type of Class II electronic game including bingo-based games or random-number based electronic wagering games.

As noted above, the rules for winning and/or pay tables may be different for each of the electronic wagering games 503-506. Electronic wagering game 503, for instance, may be a scratch and win game that provides different types of multipliers, wagering game 504 may provide different winning patterns that involve wild cards, wagering game 505 may provide different winning patterns or pay tables that provide instant cash, and wagering game 506 may provide scratchable locations that provide rescratches (i.e., rescratchable locations on the game card). Each of these games will be described in greater detail below.

Notably, the game controller (e.g., 202 of FIG. 2) may allow all four (or substantially any number) of these independent electronic wagering games on a single electronic game card and may control all four games based on a single electronic wagering game event. Controlling all of these simultaneous, independent electronic wagering games based on a single event allows the game controller to control these games using many fewer CPU cycles, less RAM, and using less CPU-to-RAM bandwidth over a front-side bus through a north bridge memory controller. In the case of four simultaneous games, for example, the CPU may use 75% fewer CPU cycles generating wagering game events for that set of games. If more games were being played simultaneously, the savings in CPU cycles and memory use would be commensurately greater.

For instance, step 420 of method 400 may include initiating, by the game controller, an electronic wagering game event that applies to each of the independent electronic wagering games. In the embodiment shown in FIG. 5A, the electronic wagering game event may apply to each of the electronic wagering games 503-506 simultaneously upon occurrence. In some embodiments, the electronic wagering games 503-506 may be bingo-based scratchable location games or "scratch and win" games in which a user seeks to match symbols or numbers based on a bingo-based draw. Thus, in such cases, the game controller (e.g., 202) may initiate a random number draw or "ball draw" using a dynamically generated random number. This ball draw may be an "electronic wagering game event" that applies to each of the electronic wagering games in the electronic game card. Other types of electronic wagering game events (e.g., die rolls, randomly generated numbers, etc.) may additionally or alternatively be used. The results of the random ball draw may then be applied to each of the electronic wagering games 503-506 simultaneously and/or to any replay bonus games that may subsequently occur.

In some embodiments, a bingo-based ball draw may be implemented as part of a game of chance. In various embodiments, as noted above, the electronic wagering games 503-506 of FIG. 5A may each include any suitable game of chance. For example, in at least some embodiments, the electronic wagering game may be a Class II bingo game or bingo-based game. In some cases, a Class II bingo game may include a bingo game display portion (e.g., 242) and scratchable location game display portion (e.g., 240). The bingo game display portion may include or may display a bingo card (e.g., at 304), and a bingo number listing (e.g., 306A). The bingo number listing, more commonly referred to as a "ball call," may be randomly generated and may increase to a maximum of seventy-five numbers (or balls called) until a game-ending pattern is awarded to a player participating in the bingo game. Other bingo game implementations with fewer or greater maximum number of balls called are possible.

One common game-ending pattern is a blackout pattern. Other game-ending patterns are also possible. When the game-ending pattern is awarded, the bingo number listing may be reset, and the process repeats. During play of the bingo game (e.g., prior to the occurrence of a game-ending pattern), a player may be provided a bingo card (e.g., at 304) each time a wager is placed. For example, a player may be provided a new bingo card each time a "Spin" or "Play" button is pressed by the player. The bingo card may be compared to the current bingo number listing, and numbers on the bingo card matching numbers in the bingo number listing may be marked, "daubed," or "scratched" on the bingo card.

Finally, the daubed or scratched bingo card may be evaluated against a pay table of winning bingo patterns. Specifically, if the bingo card includes a pattern that matches a pattern in the pay table of winning patterns, an award is provided to the player in the bingo or bingo-based game. In some embodiments, the player may be awarded for multiple patterns (e.g., all patterns) that are matched when the bingo card is evaluated against the pay table of winning patterns. In other embodiments the player may be awarded for only the highest priority pattern (e.g., the highest paying pattern) that is matched. In some embodiments, during play of a Class II game, a player may be provided a single bingo card for multiple plays of the bingo game, with a new bingo number listing generated for each play of the bingo game.

Other methods of play of a Class II bingo game are also possible and are within the scope of this invention. For instance, some winning patterns in a scratchable location game may provide "interim wins" that pay out lesser amounts for partial matches. Indeed, in some embodiments, the first range of balls (e.g., the first 40) of the ball call may be used evaluate an electronic game card for interim wins that occur during the full ball call (i.e., up to all 75 balls). These interim wins may be paid out in addition to game ending wins that may also occur on the41s^{t} to ₇₅^{t}h ball draw in a game that implements 75 bingo balls.

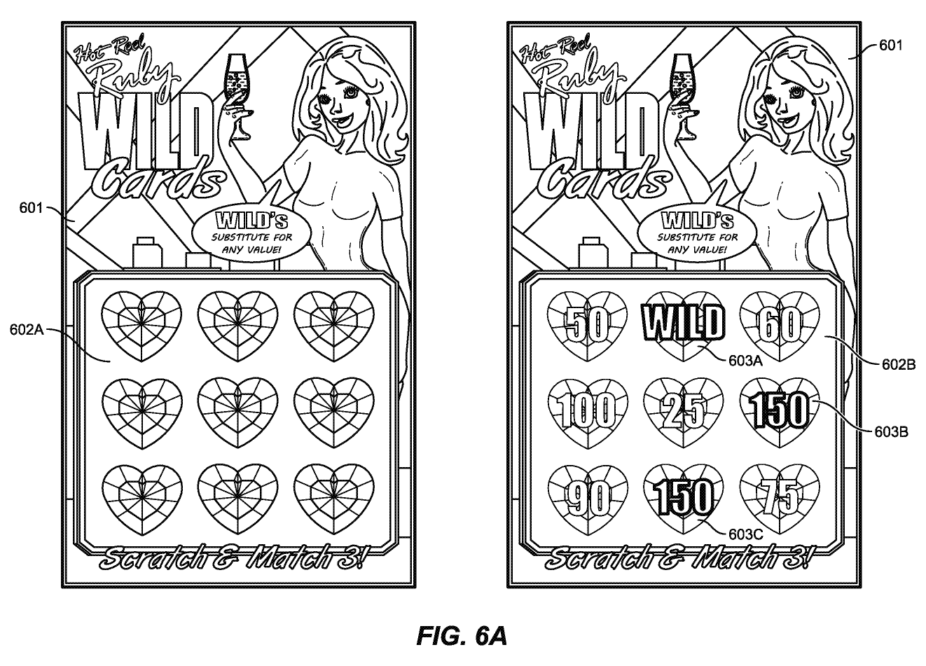

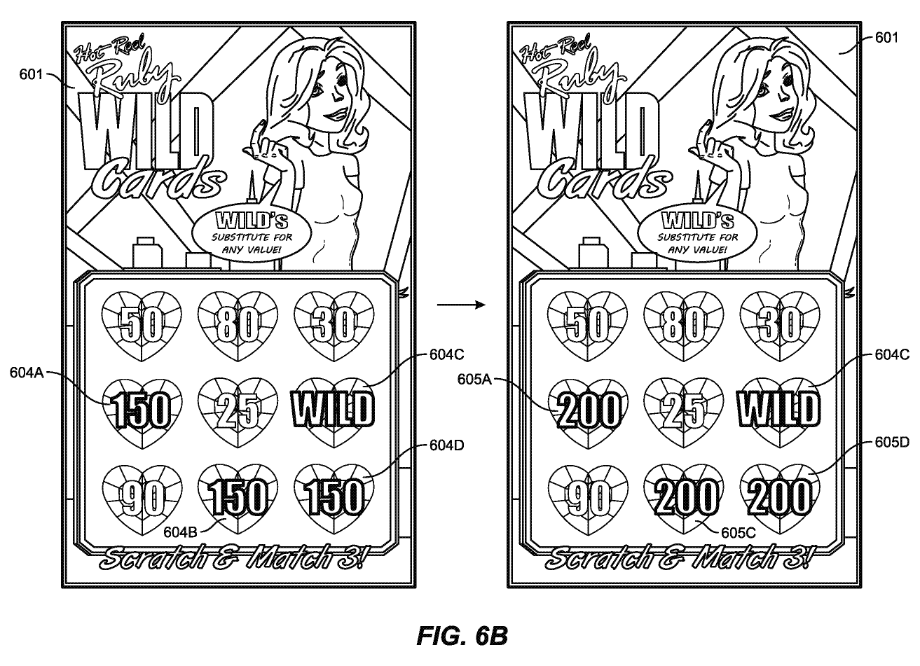

In conjunction with the underlying main bingo game, multiple scratchable location games are shown in FIG. 5A. Specifically, multiple different scratchable location games 503-506 are displayed within user interface 501. Each time a main bingo card is daubed and evaluated, the outcome of the evaluation is mapped to an outcome in each scratchable location game's facade. For example, a winning bingo game outcome may be mapped to a winning combination of scratchable locations (e.g., as shown in FIG. 6A). Similarly, a non-winning bingo game outcome may be mapped to a non-winning combination of scratchable locations. Thus, the results of the bingo game are mapped to a scratchable location game facade that simply reflects an outcome of the bingo game as a particular combination of scratchable locations.

Returning to FIG. 4, at step 430, the game controller (e.g., 202) may further generate specified graphics changes for each of the electronic wagering games (e.g., 503-506) based on the initiated electronic wagering game event (e.g., the bingo ball draw). Then, at step 440, the game controller may dynamically update, on the display device, each electronic wagering game presented in the UI using the generated graphics changes. As noted previously, the game controller may generate a user interface 501 that includes multiple different graphical elements displayed to a user. The graphical elements may include an indication of an available jackpot 502, various independent electronic wagering games 503-506, various indicators of progress or winnings (e.g., 507, 508, 509), as well as other graphical indicators or controls.

On the UI 501, a player may see many different electronic wagering games and, in some cases, many different types of games. In FIG. 5A, each of the electronic wagering games is different, while in FIG. 5B, each of the games is the same game (e.g., 504A, 504B, 504C, and 504D are different instances of the same game). Regardless of which types of games are played, each game may be controlled by or triggered by common in-game events (e.g., ball draws) that apply to each independent game in the UI 501.

In some embodiments, as shown in FIG. 5C, the rules for winning the electronic wagering games may incorporate various specified wining patterns for scratchable locations. For example, these winning patterns may include a star pattern, as indicated in game board 505A. In game board 505A, the bolded game elements (e.g., scratchable locations) may represent a winning pattern, such that if those locations include a match, the game board may offer an original prize or an enhanced prize. Similarly, game board 505B shows a pattern in which corner locations may be winning locations if matched. Likewise, game board 505C shows a diamond- shaped pattern, while game board 505D shows a diagonal pattern. Other patterns, including randomly shaped patters with other squares, are also possible. Moreover, at least in some cases, these winning locations may not match exactly in value and kind, but may share at least one common characteristic (e.g., shape or value) in order to match in the winning locations.

FIGS. 6A and 6B illustrate embodiments of an electronic scratching game that involves wild cards. Like many electronic scratching games, the wild card scratching game 601 may include multiple scratchable locations (e.g., 603A, 603B, 603C, etc.) in which a user aims to form a winning pattern on an electronic game card 602A/602B. In some cases, when an initial electronic game card is shown (e.g., 602) of FIG. 6A, a player may select or otherwise interact with a single UI element that, upon selection, scratches all of the scratchable locations (e.g., 603A-603C) in the scratch and match game 601. In some embodiments, this single selection may scratch all of the scratchable locations of each of the electronic wagering games shown on the user interface (e.g., 501 from FIG. 5A). In other cases, the player of the electronic wagering games may interact with the UI to individually select at least some or all of the scratchable locations on the electronic game card. In some cases, each player may have the option of auto-scratching all locations or individually selecting the locations as desired.

The embodiment of FIG. 6A illustrates a scenario in which, after a series of electronic wagering game events (e.g., ball draws or die rolls, etc.), the wild card scratching game 601 (e.g., which may be electronic wagering game 504 of FIG. 5A) may include a win that is completed with a wild card. Thus, in FIG. 6A, because the user scratched two "150" elements and a "wild" element, the user would win 150 credits, dollars, euros, etc. In another embodiment, as shown in FIG. 6B, a user may receive an enhanced win that, itself, includes a natural win and at least one wild in a scratchable location.

Thus, for example, in FIG. 6B, the user may receive a natural win with three "150s" (604A, 604B, and 604D). Because the user also scratched a wild 604C, the user would be entitled to an enhanced win that may be boosted. In this example, the values of the 150 locations may be changed to 200 (e.g., 605A, 605C, 605D), while the wild 604C may remain the same. In this game, the pay table may designate higher payout values for occurrences of a natural win and a wild on top of the natural win. In another example, the wild may be combined with the other symbols to create multiple three non-natural matching symbol wins, e.g., by combining the wild with each combination of two matching symbols (e.g., for 602A, three matching symbol combinations of "150s" for a total award of 450 credits). Thus, in this game, and potentially in other electronic wagering games, a wild in at least one scratchable location may enhance other natural wins. The wild may also create other, non-natural wins (e.g., if the wild was scratched in addition to two other "80" locations or two other "50" locations).

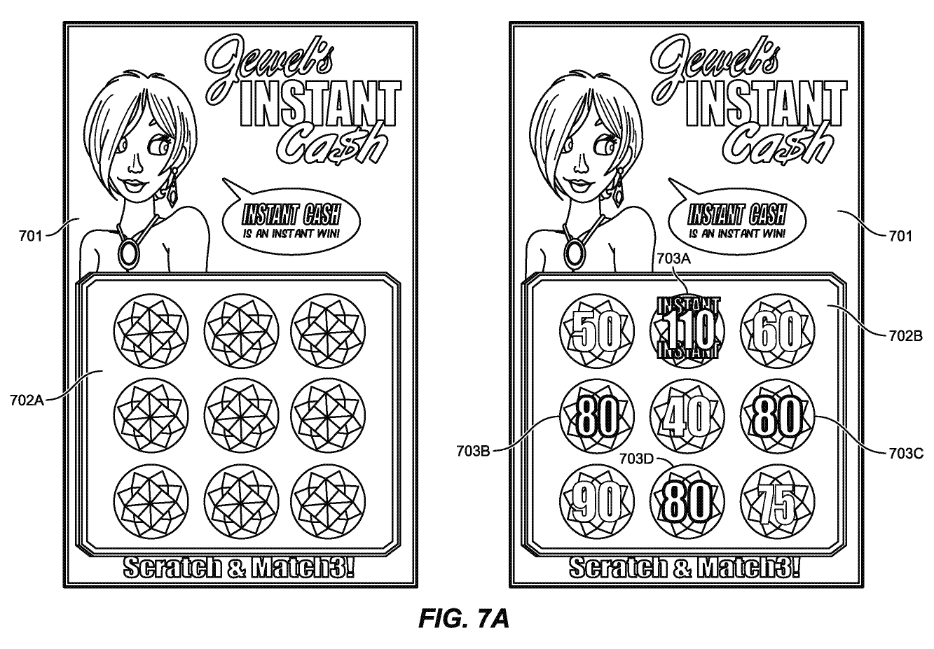

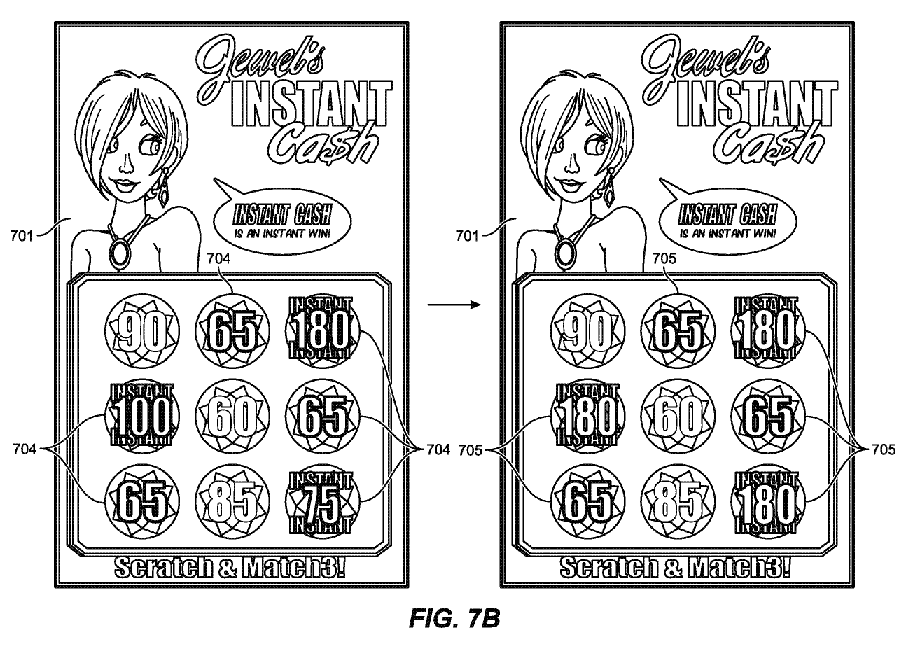

FIGS. 7A and 7B illustrate an embodiment of a different electronic wagering game that may be played as one of the multiple independent games shown in the user interface 501 of FIG. 5A. This game, like the others shown in FIG. 5A, may be controlled or triggered by a series of electronic wagering game events. These events, as noted above, may include bingo ball draws, die rolls, randomly generated numbers, etc. In some cases, after a series of electronic wagering game events have occurred (e.g., multiple bingo balls have been randomly drawn), the scratch and win electronic wagering game 701 may include instant cash scratchable locations (e.g., 703A). These instant cash scratchable locations may, in this particular electronic wagering game, result in a win without having a winning pattern.

For instance, this scratch and win electronic wagering game 701 may include an electronic game board or game card 702A. The game card 702A may include some number of scratchable locations (e.g., nine, in this instance). The player of the game may manually scratch each scratchable location by selecting that location, or the player may select a single UI element that scratches all of the scratchable locations at once. As can be seen in the updated game card 702B, the user may have a natural win with three "80" locations, 703B, 703C, and 703D. The "instant win" location 703A may result in an additional amount of winnings or credits (e.g., 110 extra credits, in this instance). Thus, in this scratch and win game, the user would win 80 credits for the natural match of three similar elements, with an additional 110 credit bonus win, for a total of 190 credits (e.g., dollars, or other denomination). In cases where no natural wins exist on the game board, the instant cash may be paid out at face value, regardless of whether any natural wins exist on the game board.

In some cases, after a series of electronic wagering game events, the scratch and win electronic wagering game 701 may include a natural match and multiple instant cash scratchable locations. For example, as shown in FIG. 7B, 704 may include three "65" locations, providing a natural win of 65 credits, while also including three instant win locations. In this example, having three instant cash locations on the game card may trigger a boost to the highest instant cash value (e.g., 180). Thus, all three instant win locations 705 may be bumped up to 180 for a total of 540 credits. The natural win of 65 credits may be added on top for a grand total of 605 credits. In this manner, the instant cash scratchable location with the highest value may be applied to each of multiple different instant cash scratchable locations. If the user had overturned four, five, or more instant cash locations, each of those would pay at the value of the highest instant cash location. The appearance of certain credit amounts and the appearance of instant cash locations (and their amounts) may be based on the bingo-based ball draw described above, and these same bingo ball draws may apply to each of the plurality of electronic wagering games being played simultaneously by the user.

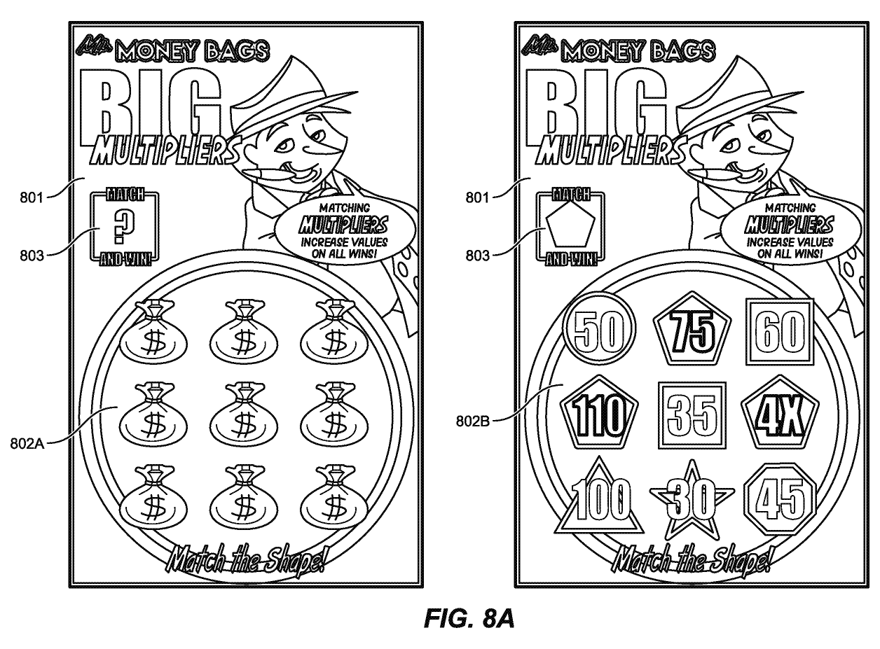

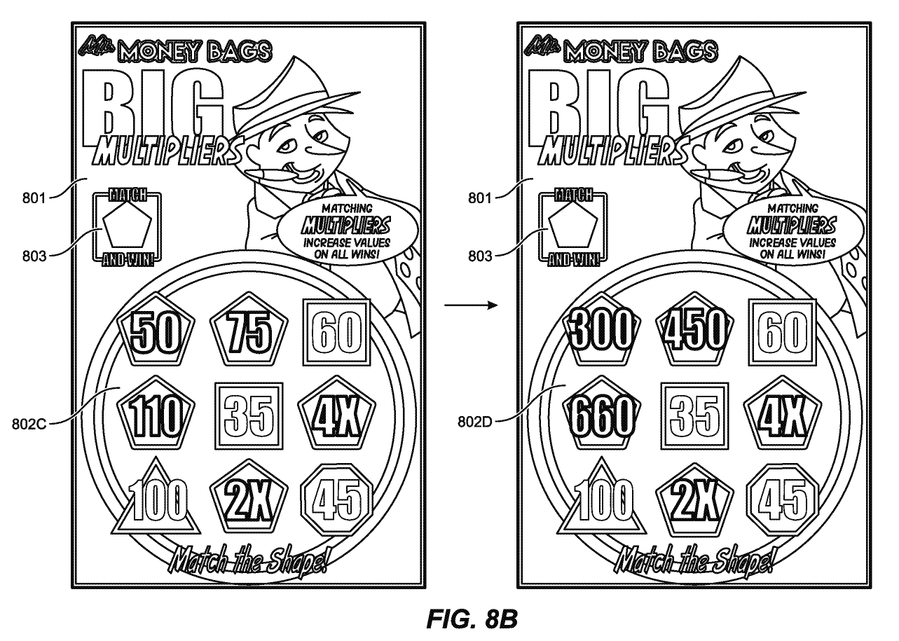

In some cases, the electronic wagering game event may cause a shape to be selected from among multiple different shapes. For instance, as shown in FIG. 8A, a scratch and win electronic wagering game 801 may include a shape box 803 that identifies a specific shape. This shape may be chosen randomly based on a bingo ball draw, a die roll, a randomly generated number, or other game event. In FIG. 8A, the selected shape is a pentagram and, as such, any scratchable locations having that shape, may be winning locations. Thus, scratchable location on game board 802A, upon being scratched, may reveal a pentagram shape and an underlying monetary value (e.g., 110 and 75 credits) award.

Other scratchable locations (e.g., on game board 802B) may also have the winning, pentagram shape, containing non-monetary prize enhancing awards. In such cases, the award revealed in each location that has a winning shape may be added or applied to a winning total award payable to the user. In some examples, either or both of the selected winning shape and the awards appearing in the various shapes may be randomly determined based on the electronic wagering game event. As shown in FIG. 8A, a shape may include an award enhancing multiplier value which, when revealed in a matching shape, may be applied to any winning total credit award payable to the player. For instance, as shown in FIG. 8A game board 802B, three matching pentagon shapes are identified comprised of 75 and 110 credit award amounts and a 4X award multiplier, awarding the player a total of 4 times 185 credits, i.e., a total award of 740 credits.

FIG. 8B may also illustrate an embodiment of a scratch and win electronic wagering game 801 that pays out value for scratchable locations having the specified shape 803. In this game, as above, scratchable locations having a selected shape may be winning locations, winning a monetary amount specified in those scratchable locations that have the selected shape. In the game board 802C, a user has received five winning scratchable locations, with three specifying numerical amounts (e.g., 50, 75, and 110) and two specifying multipliers (e.g., 2X and 4X). The 2X and 4X multipliers may then boost the matching wins by 6X (e.g., 300, 450, and 660). Thus, in game card 802D, with the 6X boost, the user would have won a grand total of 1410 (e.g., 300 + 450 + 660). In this manner, shapes and multipliers may be implemented to determine winning patterns and winning pay tables. In another case, the multipliers may be applied to the award amounts individually, e.g., multiplying the awards first by 2X and then 4X, (e.g., 400, 600, and 880) to award the player a total of 1880 credits.

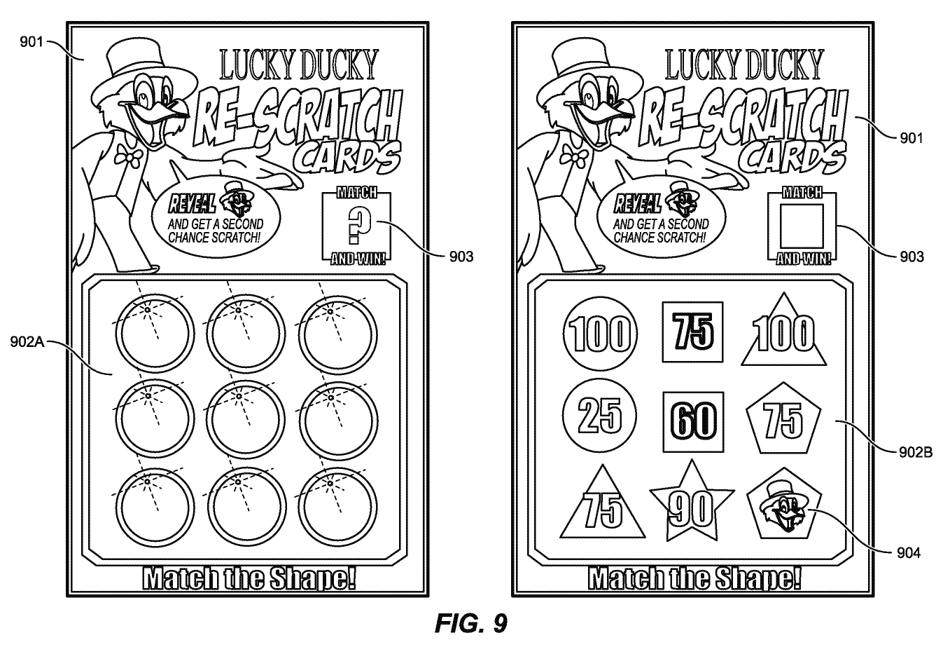

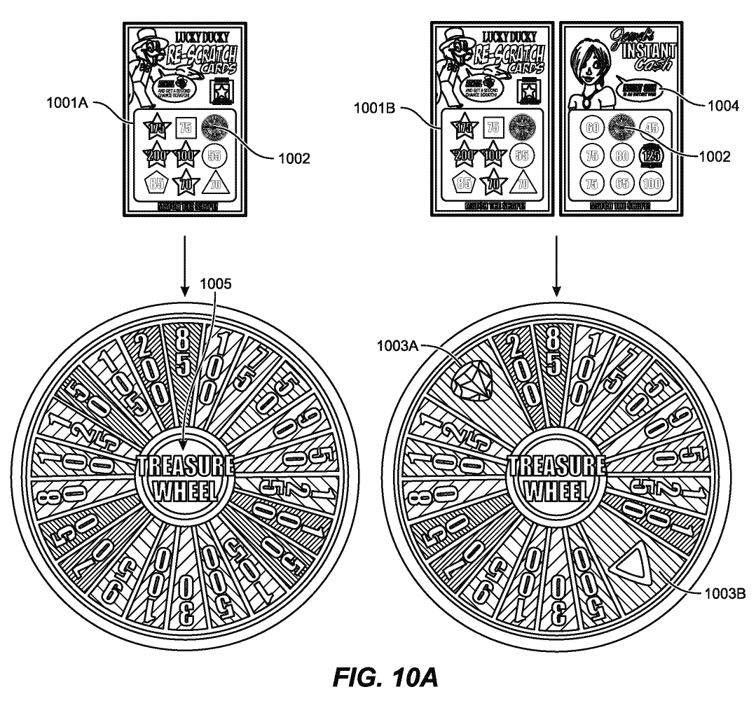

FIG. 9 illustrates an embodiment of a scratch and win electronic wagering game 901. This particular electronic wagering game 901 may be played alone (e.g., in multiple instances) or in combination with other electronic wagering games, as shown in FIG. 5A. In some cases, after a series of electronic wagering game events (e.g., bingo ball draws), the electronic wagering game 901 may include at least one scratchable location that allows each losing scratchable location within the game to be rescratched. Thus, in electronic wagering game 901, a game board 902A may include multiple scratchable locations. Once these locations have been scratched, as shown in the updated game board 902B, those locations that have a specific shape may be winners.

In this embodiment, the selected shape 903 (e.g., selected based on the bingo ball draw) is a square, although other shapes or indicators may be used. Any scratchable location that has that shape or indicator, after being scratched, may be a winner. Because the "60" and "75" values are square-shaped, but do not match, they are not winners. However, because the bottom right location 904 includes a duck's head (or other indicator), the user may rescratch the non-winning locations. Thus, the "60" and "75" locations may be rescratched and provide any winnings if a natural match is formed. If, on the rescratches, the user uncovers another duck head or other rescratch indicator, the losing locations may again be rescratched. This process may continue until no further rescratch indicators are uncovered.

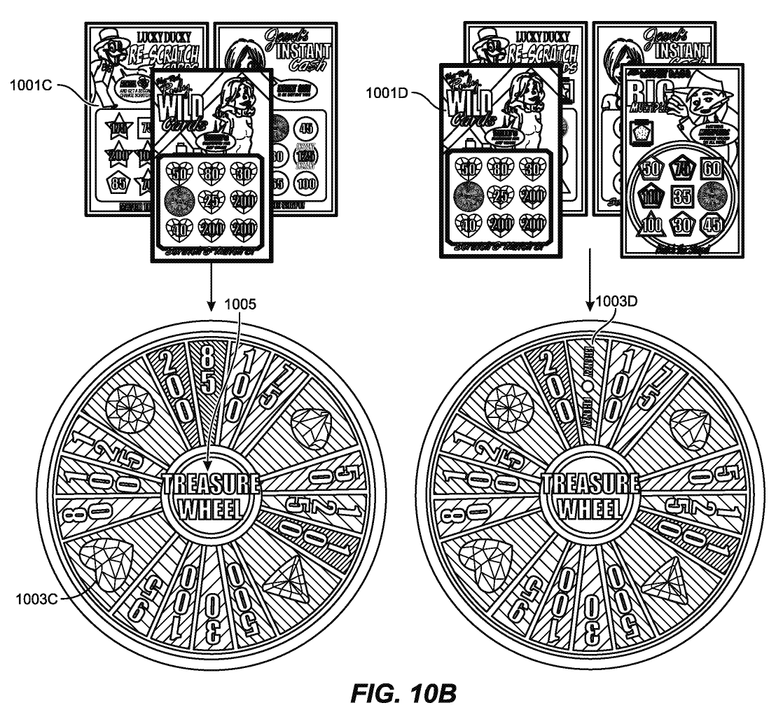

FIGS. 10A and 10B illustrate examples in which a wheel bonus may be implemented in some or all of the electronic wagering games selected by the user. Indeed, as noted above, the user may be able to play multiple different games with different rules and different payouts simultaneously. Each of those games may be based on the same electronic wagering game events or triggers. In some embodiments, the user may be able to select each game that is to be played. In such cases, the game controller may present, on the user interface, multiple different selectable games that can be played simultaneously. The user may then interact with the display device to dynamically add, dynamically remove, or dynamically replace the selected games. Thus, for example, the user may click on or touch an icon associated with a game to add or remove it to the games being played. In other cases, the user may drag and drop an image of a game onto the field of games or off of the field of games. In this manner, users may continually change which games are being played, including the number of games, the type of games, or the number of instances of a particular game.

In some cases, after a series of electronic wagering game events, at least one of the electronic wagering games may include one or more scratchable locations that have a wheel bonus feature award trigger symbol (i.e., a wheel spin 1002). For example, in FIG. 10A, a wheel bonus feature may be activated for any or all of the electronic wagering games 1001A or 1004. On the left side of FIG. 10A, a rescratch electronic wagering game may be provided in which at least one wheel spin 1002 is uncovered. This wheel spin 1002 may allow the user to spin a feature "treasure wheel" 1005 to receive more prizes (e.g., money or credits). If the scratcher card has one wheel spin 1002 symbol, the treasure wheel 1005 may include only various credit amounts that can be won by the user. On the right side of FIG. 10A, two of the electronic wagering games (e.g., 1001B and 1004) the user is playing simultaneously may have wheel spins 1002. In such cases, because multiple games included a wheel spin 1002, the treasure wheel 1005 may include specialized locations (e.g., 1003A and 1003B) that provide special prizes (e.g., jackpot prizes shown at 508 in FIG. 5A).

At least in some embodiments, the more wheel spins that are uncovered in different scratch games, the more specialized locations appear on the treasure wheel 1005. The user can then activate the treasure wheel to cause it to spin, after which the player will win at least one of the prizes depicted on the wheel. In some embodiments, if each of the electronic wagering games in the user interface (e.g., 501 of FIG. 5A) has a wheel bonus, at least one instant win location may be added for each electronic game card to the treasure wheel 1005.

FIG. 10B illustrates, on the left side, an embodiment in which three scratcher games 1001C include treasure wheel symbols. This may cause additional special locations 1003C to be dynamically added to the treasure wheel 1005. And, on the right side, an embodiment is illustrated in which four scratcher games 1001D include treasure wheel symbols. As such, the corresponding treasure wheel 1005 may include multiple different additional special locations 1003D that may give the user additional chances to win special prizes of potentially higher value.

In some embodiments, the rules for winning the electronic wagering games may incorporate various specified wining patterns for scratchable locations. These winning patterns may include star patterns, corner patterns, diamond-shaped patterns, randomly selected patterns, or other types of patterns. In some examples, when a user wins at least one of the electronic wagering games (e.g., one of the games shown in UI 501 of FIG. 5A), at least one bonus electronic game card may be displayed in the UI. This electronic game card may be a wining card that will pay out at least one prize.

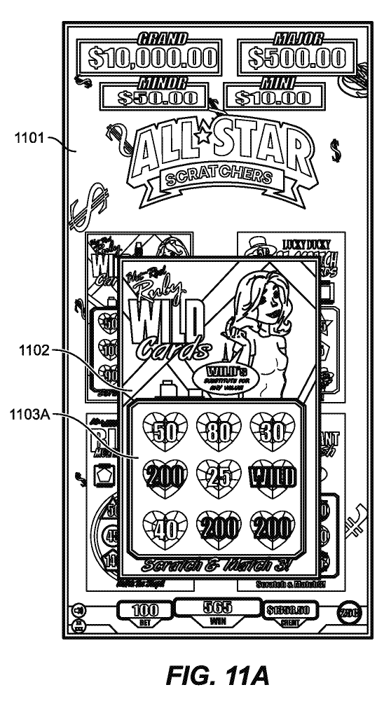

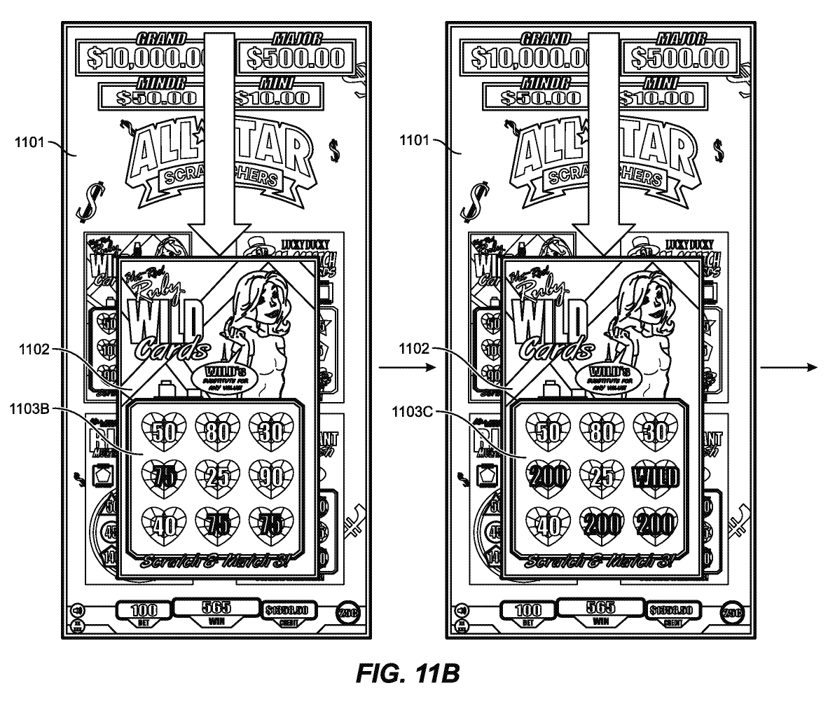

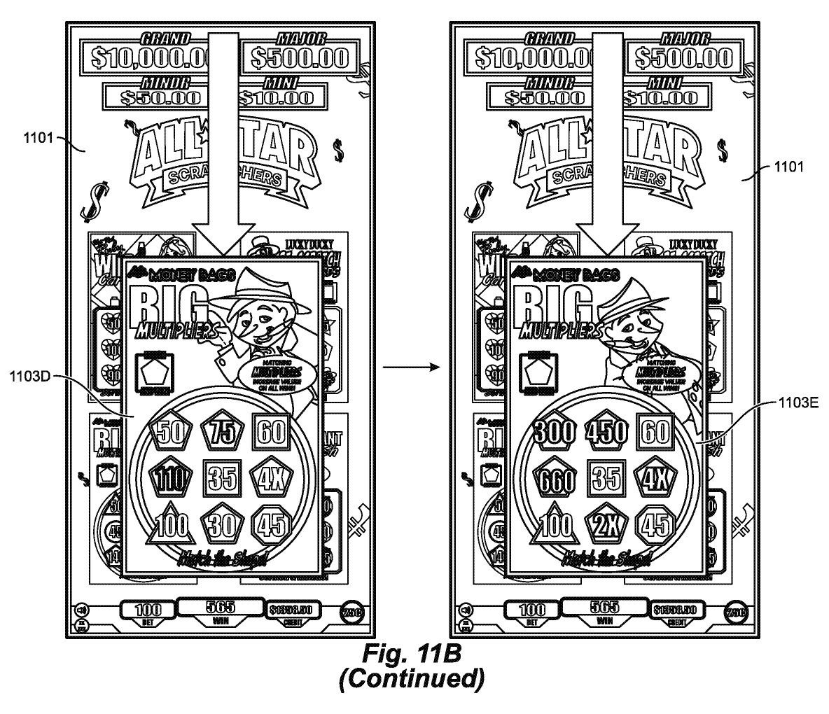

For example, as shown in FIG. 11A and 11B, in some cases, a free scratch card may be awarded to a user. This scratch card may be in addition to the initial game card(s) that started the game 1101. In some embodiments, if a user achieves multiple bingo pattern wins on a single card (or if some other winning trigger occurs), the electronic wagering game may present an additional, free bonus card 1102 that may be colored or highlighted or designed to convey its special properties. In some cases, this bonus electronic game card 1102 may be displayed for each of the electronic wagering games that achieved multiple bingo pattern wins. In some examples, each of the scratchable locations 1103A in the bonus electronic game card 1102 may automatically be scratched and tallied for each electronic wagering game. In other cases, the user may manually scratch the scratchable locations in the bonus card.

On the left side of FIG. 11B, a user may achieve multiple winning patterns on multiple cards. In such cases, a bonus card 1102 with scratchable locations 1103B may be presented to the user within the game 1101. Because the user achieved a natural match (e.g., three locations with "75"), the game controller may cause another bonus game card to be generated and displayed within the user interface of the game 1101. This bonus card, with its unique scratchable locations 1103C, may also be autoscratched and tallied for the user. In this case, three "200's" matched, along with the "Wild" location.

The bonus cards may continue with scratchable locations 1103D for a different game (another one of the independent electronic wagering games that had at least one winning pattern). This bonus card may also be automatically scratched and evaluated for matching shapes by the game controller. In this case, multiple of the scratchable locations 1103E match the selected shape, thus paying out based on the credit awards and multipliers obtained through the shape matching. In some cases, the odds of obtaining a bonus electronic game card may increase based on the number of electronic wagering games that are being played simultaneously by the user. This, in turn, may increase the frequency of bonus cards and increase the enjoyment of the player.

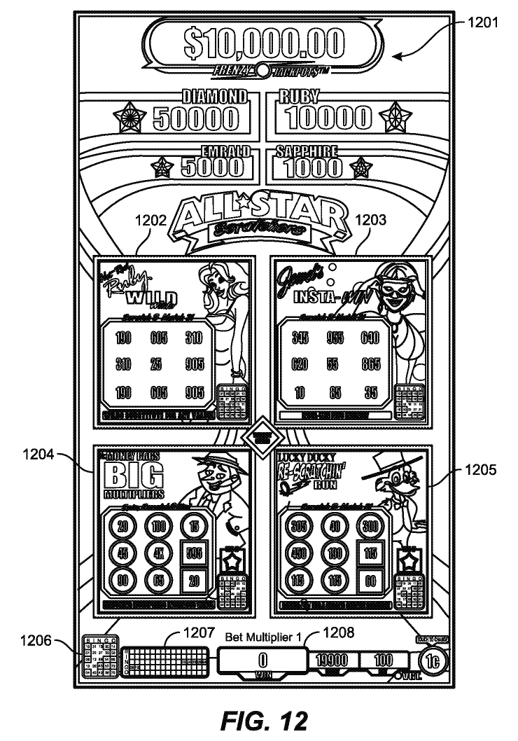

FIG. 12 illustrates an embodiment of an electronic wagering game 1201. The electronic wagering game 1201 may be a Class II, bingo-based game. This embodiment of the electronic wagering game 1201 may include four different scratcher games (1202, 1203, 1204, and 1205) that may each have its own rules for winning. At least in some cases, the four different scratcher games may operate using a common bingo seed. The common seed may be provided by an underlying bingo game 1206. That bingo game 1206 may implement a ball call 1207 that provides numbers for the bingo squares in bingo card 1206. This ball call 1207 may be used for one, two, three, or all four of the four-up games 1202, 1203, 1204, or 1205. When certain patterns are achieved in the bingo card 1206, the user may be awarded certain prizes (e.g., shown at 1208) in each of the scratcher games.

As can be seen, in FIG. 12, in the bottom right corner of each multi-up game, each game may have its own corresponding bingo card. This bingo card may or may not be visible during actual gameplay of the multi-up scratcher games 1202-1205. Each bingo card may be filled based on which balls have been drawn in the ball call 1207. Each multi-up game has a different bingo pattern in its corresponding bingo card based on which numbers were initially populated in its bingo card and which numbers have been called in the common ball call. Thus, the embodiment in FIG. 12 shows how an underling bingo game with a common ball draw 1207 may be used as a shared seed to multiple simultaneous games in a multi-up format.

In at least some embodiments, this disclosure may achieve various technical effects and/or technical benefits including at least one of: (i) an ability to provide a common seed to multiple simultaneous scratcher games; (ii) an ability to display large quantities of complex information in a relatively small display area; (iii) an ability to communicate complex information with easy-to-understand animations on a display; (iv) an ability to efficiently communicate different game rules on a display during gameplay; and (v) an ability to provide versatility as to which devices (e.g., EGMs, mobile devices, etc.) the games described herein may be played on due to the efficient display area designs described herein.

Example embodiments described herein may be provided in combination or in isolation to summarize and present game mechanics in a manner that improves the efficiency of computer systems (e.g., electronic gaming systems including electronic gaming devices). Each example system provides an improved user interface displaying a limited set of information to players, potentially within a small screen, such that players can more quickly understand the current status of the game. The systems and methods provide improved display device functionality (e.g., on a gaming device) by providing multiple visual indicators that communicate game mechanics described herein to players. The systems and methods provided herein also improve display and device efficiency by eliminating the need for complex information pages describing game mechanics to players. Because of at least the easily-understood animations, symbols, and indicators displayed, the games described herein can be played and understood on a single screen substantially smaller than some of the EGMs described herein (e.g., a mobile device such as a cell phone), thus removing the need for multiple displays with complex information screens including lengthy text.

At least in some cases, when a win amount is determined for a play, a random determination is made as to whether a bonus feature or bonus game will be provided (e.g., based at least in part upon whether the win amount is above a threshold amount defined in memory). If not, the win amount may be provided with a base game play or a combination of a base game plays and other bonus games. If a bonus feature is to be provided, the win amount may be utilized to perform a lookup for a set of presentations stored in memory and associated with that win amount. One of the presentations from the set of presentations is then selected (e.g., randomly), and is utilized to display the bonus feature and provide the win amount. In some embodiments, for example, as in FIG. 11A, a bonus electronic game card 1102 may be displayed as a presentation for each of the electronic wagering games that achieved multiple bingo pattern wins.

By generating and storing presentations for selection according to the various embodiments explained herein, computer efficiency is increased, and computer resources are saved at least because the presentations allow for fewer determinations to be made by a gaming device and/or server as the game is being played. Various presentations being stored for the same win amount also increases variability in how win amounts may be provided because, while the same total win amount may be provided multiple times during play of the game, that same win amount may be provided with different combinations of the base game and/or the bonus electronic game cards.

In some embodiments, a corresponding method of electronic gaming may also be provided. The method of electronic gaming may be implemented by an electronic gaming system that includes at least one processor in communication with at least one memory device and a display device. The method may include: causing display, on the display device, of a user interface (UI) that includes multiple independent electronic wagering games, where at least two of the electronic wagering games have different rules for winning and/or different associated pay tables. The method may also include initiating an electronic wagering game event that applies to each of the independent electronic wagering games, generating specified graphics changes for each of the electronic wagering games based on the initiated electronic wagering game event, and dynamically updating, on the display device, each electronic wagering game presented in the UI using the generated graphics changes.

A corresponding non-transitory computer-readable medium may further be provided that includes one or more computer-executable instructions that, when executed by at least one processor of a computing device, cause the computing device to: cause display, on the display device, of a user interface (UI) that includes multiple independent electronic wagering games, where at least two of the electronic wagering games have different rules for winning and/or different associated pay tables. The computing device may also initiate an electronic wagering game event that applies to each of the independent electronic wagering games, generate specified graphics changes for each of the electronic wagering games based on the initiated electronic wagering game event, and dynamically update, on the display device, each electronic wagering game presented in the UI using the generated graphics changes.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term "memory device" generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term "physical processor" generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term "computer-readable medium" generally refers to any form of device, carrier, or medium capable of storing or carrying computer-readable instructions. Examples of computer-readable media include, without limitation, transmission- type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid- state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms "connected to" and "coupled to" (and their derivatives), as used in the specification and claims, are to be construed as permitting both direct and indirect (i.e., via other elements or components) connection. In addition, the terms "a" or "an," as used in the specification and claims, are to be construed as meaning "at least one of." Finally, for ease of use, the terms "including" and "having" (and their derivatives), as used in the specification and claims, are interchangeable with and have the same meaning as the word "comprising."

What is claimed is:

1. An electronic gaming machine comprising:
a display device; and
a game controller in communication with the display device, the game controller including at least one processor and at least one memory, wherein the game controller is configured to:cause display, on the display device, of a user interface (UI) that includes a plurality of independent electronic wagering games, wherein at least two of the electronic wagering games have different rules for winning and/or different associated pay tables;initiate an electronic wagering game event that applies to each of the plurality of independent electronic wagering games;generate a plurality of graphics changes for each of the plurality of electronic wagering games based on the initiated electronic wagering game event; anddynamically update, on the display device, each electronic wagering game presented in the UI using the generated graphics changes.

2. The electronic gaming machine of claim 1, wherein at least two of the electronic wagering games comprise electronic scratching games in which a user forms a winning combination in a plurality of scratchable locations on an electronic game card.

3. The electronic gaming machine of claim 2, wherein a player of the plurality of electronic wagering games interacts with a single UI element that, upon selection, scratches each of the scratchable locations in each of the plurality of electronic wagering games.

4. The electronic gaming machine of claim 2, wherein a player of the plurality of electronic wagering games interacts with the UI to individually select at least a plurality of the scratchable locations on the electronic game card.

5. The electronic gaming machine of claim 2, wherein, after a series of electronic wagering game events, at least one of the electronic wagering games includes an enhanced win that, itself, includes a natural win and at least one wild in a scratchable location.

6. The electronic gaming machine of claim 2, wherein a wild in at least one scratchable location enhances one or more natural wins and creates at least one other, non- natural win.

7. The electronic gaming machine of claim 2, wherein, after a series of electronic wagering game events, at least one of the electronic wagering games includes an instant cash scratchable location that results in a win without having a winning pattern.

8. The electronic gaming machine of claim 2, wherein, after a series of electronic wagering game events, at least one of the electronic wagering games includes a natural match 57
and a plurality of instant cash scratchable locations, such that the instant cash scratchable location with the highest value is applied to each of the plurality of instant cash scratchable locations.

9. The electronic gaming machine of claim 2, wherein the electronic wagering game event comprises a shape selected from among a plurality of different shapes, and wherein scratchable locations having the selected shape are winning locations, winning a monetary amount specified in those scratchable locations that have the selected shape.

10. The electronic gaming machine of claim 2, wherein, after a series of electronic wagering game events, at least one of the electronic wagering games includes at least one scratchable location that allows each losing scratchable location within the at least one electronic wagering game to be rescratched.

11. The electronic gaming machine of claim 10, wherein, after rescratching the losing scratchable locations, at least one scratchable location again includes an element that allows losing scratchable locations to be rescratched, and at least one losing scratchable location is rescratched again.

12. The electronic gaming machine of claim 2, wherein, after a series of electronic wagering game events, at least one of the electronic wagering games includes at least one
scratchable location that comprises a wheel bonus feature triggering symbol, activating a wheel bonus feature for each of the plurality of electronic wagering games.

13. The electronic gaming machine of claim 12, wherein the wheel bonus feature includes at least one wheel spin, wherein, upon spinning the wheel, a player wins at least one prize depicted on the wheel.

14. The electronic gaming machine of claim 13, wherein if one or more of the plurality of electronic wagering games has a wheel bonus feature triggering symbol, at least one instant win prize is added to the wheel for each electronic game card with a feature triggering symbol

15. The electronic gaming machine of claim 2, wherein the rules for winning at least one of the electronic wagering games includes one or more specified winning patterns for scratchable locations including at least one of: a star pattern, a corner pattern, or a diamond- shaped pattern.

16. The electronic gaming machine of claim 2, wherein, upon winning at least one of the plurality of independent electronic wagering games, at least one bonus electronic game card is displayed in the UI, the electronic game card comprising a winning card where at least one prize will be paid out.

17. The electronic gaming machine of claim 16, wherein the bonus card is displayed for each of the plurality of electronic wagering games, and wherein each of the scratchable locations are automatically scratched and tallied for each electronic wagering game.

18. The electronic gaming machine of claim 17, wherein the odds of obtaining a bonus electronic game card increase based on a number of electronic wagering games being played simultaneously.

19. A method of electronic gaming implemented by an electronic gaming system, the electronic gaming system including at least one processor in communication with at least one memory device and a display device, the method comprising:causing display, on the display device, of a user interface (UI) that includes a plurality of independent electronic wagering games, wherein at least two of the electronic wagering games have different rules for winning and/or different associated pay tables;initiating an electronic wagering game event that applies to each of the plurality of independent electronic wagering games;generating a plurality of graphics changes for each of the plurality of electronic wagering games based on the initiated electronic wagering game event; anddynamically updating, on the display device, each electronic wagering game presented in the UI using the generated graphics changes.

20. A non-transitory computer-readable medium comprising one or more computer- executable instructions that, when executed by at least one processor of a computing device, cause the computing device to:cause display, on the display device, of a user interface (UI) that includes a plurality of independent electronic wagering games, wherein at least two of the electronic wagering games have different rules for winning and/or different associated pay tables;initiate an electronic wagering game event that applies to each of the plurality of independent electronic wagering games;generate a plurality of graphics changes for each of the plurality of electronic wagering games based on the initiated electronic wagering game event; anddynamically update, on the display device, each electronic wagering game presented in the UI using the generated graphics changes.
